(19) United States
(12) Patent Application Publication
(10) Pub. No.: US 2005/0177785 A1
(43) Pub. Date: Aug. 11, 2005

(54) Client-side pricing agent for collecting and managing product price information over the internet

(76) Inventors: Theodore Jack London Shrader, Austin, TX (US); Umesh Gopaldas Khatwani, Austin, TX (US)

Correspondence Address: IBM CORP (YA);C/O YEE & ASSOCIATES PC, P.O. BOX 802333, DALLAS, TX, 75380, US

(21) Appl. No.: 10/624,269

(22) Filed: Jul. 22, 2003

Related U.S. Application Data
(62) Division of application No. 09/578,751, filed on May 25, 2000.

(51) Int. Cl. G06F 17/00

(52) U.S. Cl. 715/513

(57) ABSTRACT

A method of collecting product data, e.g., from a plurality of web sites on the Internet. The method is operative from a client computer and utilizes a pricing agent. Using the agent, a user can generate a set of product profiles each identifying a given site URL, a list of one or more included items to be queried, a scan interval, and a site template. For a given product profile, the agent periodically retrieves data from the given site URL at the scan interval. It then parses the data retrieved according to the site template to generate a data record for each included item comprising an item name, an associated price value and, optionally, a secondary source. The retrieved data may also be compared against one or more threshold expressions to generate given actions.

### BACKGROUND OF THE INVENTION

1. Technical Field

This invention relates generally to information retrieval in a computer network. In particular, the invention provides a client-side computer program that allows users and businesses to collect and manage product price information retrieved from web sites on the Internet.

2. Description of the Related Art

The World Wide Web is the Internet's multimedia information retrieval system. In the web environment, a client machine and, in particular, a web browser, effects transactions to web servers using the Hypertext Transfer Protocol (HTTP), which is a known application protocol providing users access to files (e.g., text, graphics, images, sound, video, etc.) using a page markup language, e.g., Hypertext Markup Language (HTML), Extensible Markup Language (XML), or the like. HTML, for example, provides basic document formatting and allows the developer to specify “links” to other servers and files. In the Internet paradigm, a network path to a server is identified by a so-called Uniform Resource Locator (URL) having a special syntax for defining a network connection. Use of an HTML-compatible browser (e.g., Netscape Navigator or Microsoft Internet Explorer) at a client machine involves specification of a link via the URL. In response, the client makes a request to the server identified in the link and, in return, receives a base document formatted according to HTML. The document may include one or more references to other resources or objects that are then fetched by the browser and rendered on the client browser.

Web shopping bots and price comparison agents are in widespread use on the Internet. A shopping bot is an intelligent search engine that automatically finds the lowest price on a product that a user may desire to purchase. Many shopping sites have bots that are tailored for specific types of products. In operation, a user navigates to a comparison shopping web site, designates a given product or keyword, and initiates a search. The shopping bot then initiates a search for the user-designated item and returns the results. A comparison engine may then rank the results according to price or some other characteristic. While engines of this type are quite useful, often they provide only a single current price for the target product. They do not provide historical tracking of product pricing. Additionally, some sites, intentionally block bulk shopping bot queries. In such case, the comparison shopping sites cannot be used to obtain information from such sites.

The present invention addresses the deficiencies of known shopping sites and comparison shopping agents.

### BRIEF SUMMARY OF THE INVENTION

A client-side application (a “pricing agent”) enables a user to collect and manage product price information retrieved from various servers in a computer network such as the Internet. The pricing agent has a associated database that includes a set of tables that are generated and managed by the user and the application. These tables include a pricing profile table, a site template table, a price table and a threshold table. The pricing profile table is user-configurable and identifies which URL sites that should be scanned, what the sites should be scanned for, and what events should occur upon scanning. A given record in the pricing profile table identifies, for example: a site URL, a list of included items to be searched, matching criteria against which the included items are evaluated, a list of excluded items, a pointer to a site template, a scan interval that specifies the period that the URL site is polled and parsed for included items, a threshold expression to trigger events based on scanned price or other data, and a trigger event that identifies a given action. The site template table includes scanning templates that the pricing agent uses in conjunction with records from the pricing profile table to search item entries and their prices from a user-selected URL. A given record in the site template table is a site template that consists of a syntax notation, such as a lexical parsing template, that indicates to the pricing agent how to scan for item names and their corresponding prices in the returned contents of the URL.

The price table contains records for each item name and value, the source of the information, and the time the information was recorded. Records in the price table are preferably generated by the pricing agent when the pricing agent finds an item in the included items list of a pricing profile table record in the contents of a URL that is returned and parsed using a site template. The threshold table contains records indicating when a threshold condition is reached. A given record in this table may identify a threshold type field that indicates what type of value the threshold comparison will operate against, and the comparison value to determine if a threshold expression is satisfied.

In use, a user of a client machine first identifies sites to be searched and products to be priced from those sites. The user may also establish how frequently a given site is to be searched, as well as what actions may be taken if certain price or other conditions exist at the site or across multiple sites. The user creates such customized search criteria using a simple dialog. The pricing agent includes site templates that facilitate how each site is searched. The templates invoke search engines at the target sites, recognize the format of the HTML or other page output generated from such sites and, using user-designated matching techniques, extract the price information about the queried item(s). By querying the specified sites at periodic intervals, historical pricing information about the specified products can be generated and output to the user. In addition, the user may update the search criteria at any time. The user may set a price or other threshold at which he or she would be notified if the queried price met, was above, or was below the specified threshold. An alert may be generated if an item appears at a particular site at a particular price. A threshold action could be for the pricing agent to sell the item at a given price on the target site URL.

In an illustrative embodiment, a method is described for automating the collection of product data, e.g., from a plurality of web sites on the Internet. The method is operative from a client computer and utilizes a pricing agent. Using the agent, a user can generate a set of product profiles each identifying a given site URL, a list of one or more included items to be queried, a scan interval, and a site template. For a given product profile, the agent periodically retrieves data from the given site URL at the scan interval. It then parses the data retrieved according to the site template to generate a data record for each included item comprising an item name, an associated price value and, optionally, a secondary source.

The foregoing has outlined some of the more pertinent objects and features of the present invention. These objects should be construed to be merely illustrative of some of the more prominent features and applications of the invention. Many other beneficial results can be attained by applying the disclosed invention in a different manner or modifying the invention as will be described. Accordingly, other objects and a fuller understanding of the invention may be had by referring to the following Detailed Description of the Preferred Embodiment.

### BRIEF DESCRIPTION OF THE DRAWINGS

For a more complete understanding of the present invention and the advantages thereof, reference should be made to the following Detailed Description taken in connection with the accompanying drawings in which:

FIG. 1 illustrates a representative computer network in which the inventive client-side pricing agent is implemented;

FIG. 2 is a simplified block diagram of the main processing components of the pricing agent of the present invention;

FIG. 3 is a simplified block diagram of a pricing database that is used by the pricing agent of the present invention;

FIG. 4 is a representative configuration dialog for viewing, creating or modifying a record from the pricing profile table of the pricing database;

FIG. 5 is a flowchart illustrating the main processing flow of the pricing agent;

FIG. 6 is a flowchart illustrating a processing of a fuzzy match specification; and

FIG. 7 is a flowchart illustrating a store entry in the price table method according to the present invention.

### DETAILED DESCRIPTION OF THE PREFERRED EMBODIMENT

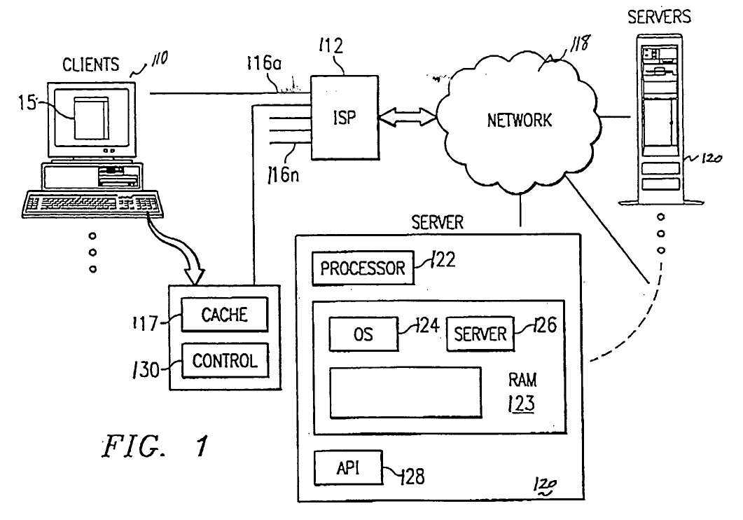

A representative system 100 in which the present invention is implemented is illustrated in FIG. 1. A plurality of Internet client machines 110 are connectable to a computer network Internet Service Provider (ISP) 112 via a network such as a dialup telephone network. As is well known, the dialup telephone network usually has a given, limited number of connections 116a-116n. ISP 112 interfaces the client machines 110 to the remainder of the network 118, which includes a plurality of web content server machines 120. Some of the Web content server machines comprise web sites at which e-commerce or other electronic transactions may be implemented with respect to identifiable products. Network 118 typically includes other servers (not shown) for control of domain name resolution, routing and other control functions. A client machine typically includes a suite of known Internet tools, including a Web browser, to access the servers of the network and thus obtain certain services. These services include one-to-one messaging (e-mail), one-to-many messaging (bulletin board), on-line chat, file transfer and browsing. Various known Internet protocols are used for these services. Thus, for example, browsing is effected using the Hypertext Transfer Protocol (HTTP), which provides users access to multimedia files using Hypertext Markup Language (HTML). The collection of servers that use HTTP comprise the World Wide Web, which is the Internet's multimedia information retrieval system.

A given client machine and the server may communicate over the public Internet, an intranet, or any other computer network. If desired, given communications may take place over a secure connection. Thus, for example, a client may communication with the server using a network security protocol, such as Netscape's Secure Socket Layer (SSL) protocol or the like.

A representative client is a personal computer, notebook computer, Internet appliance or pervasive computing device (e.g., a PDA or palm computer) that is Pentium-, PowerPC®- or RISC-based. The client includes an operating system such as Microsoft Windows, Linux, Unix, Microsoft Windows CE, BeOS, PalmOS. As noted above, the client includes a suite of Internet tools including a Web browser 115, such as Netscape Navigator or Microsoft Internet Explorer, that has a Java Virtual Machine (JVM) and support for application plug-ins or helper applications. The browser has a cache 117 associated therewith for temporary storage of given content.

A representative web server 120 is an IBM Netfinity server comprising a RISC-based processor 122, an operating system 124 (e.g., NT, Unix, Linux, Apache, or the like) and a web server program 126. OS 124 and web server program 126 are supported in system memory 123 (e.g., RAM). The server may include an Application Programming Interface 128 (API) that provides extensions to enable application developers to extend and/or customize the core functionality thereof through software programs including plug-ins, CGI programs, servlets, and the like. The present invention does not require any changes to server-side functionality, however, as will be seen.

The present invention is a pricing agent 130 that is implemented as a client-side process. The pricing agent is a computer program comprising a set of computer instructions that may be written in native or platform-independent (e.g., Java) code. The computer program is executable in a processor of the client machine. As will be seen, the pricing agent provides an architecture that allows users and businesses to collect and manage price information in a heterogeneous environment, such as various web sites on the Internet. Generally, the pricing agent is executable from the client workstation to scan and collect information from user-specified sites across the Internet.

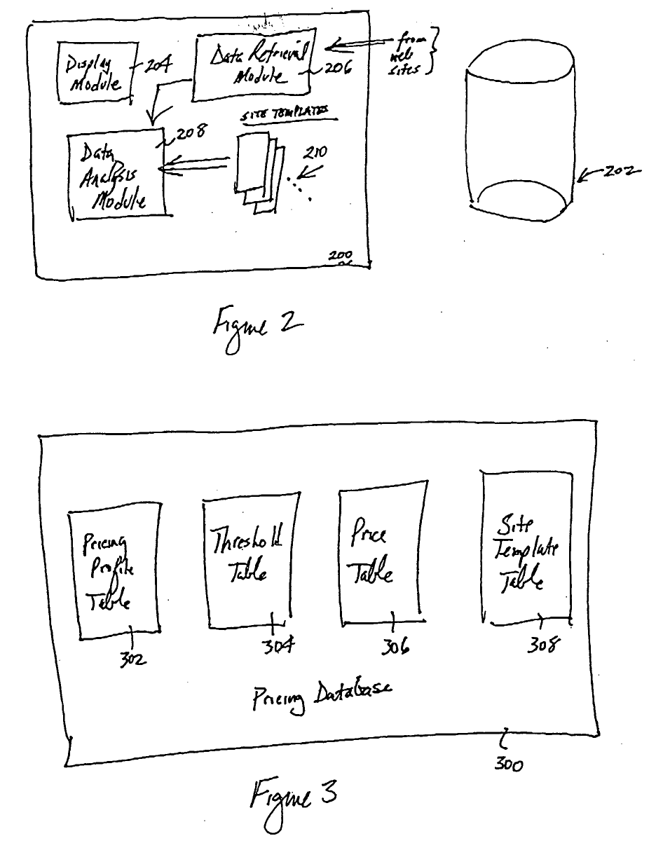

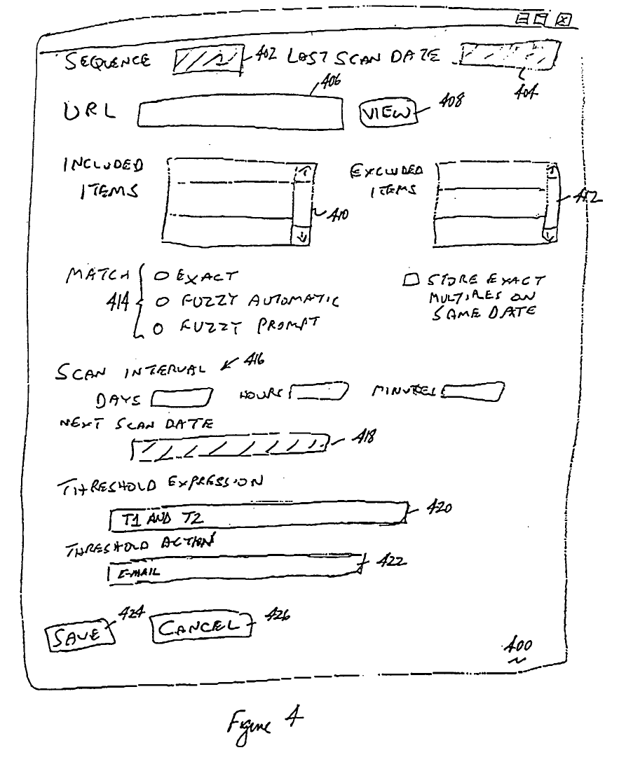

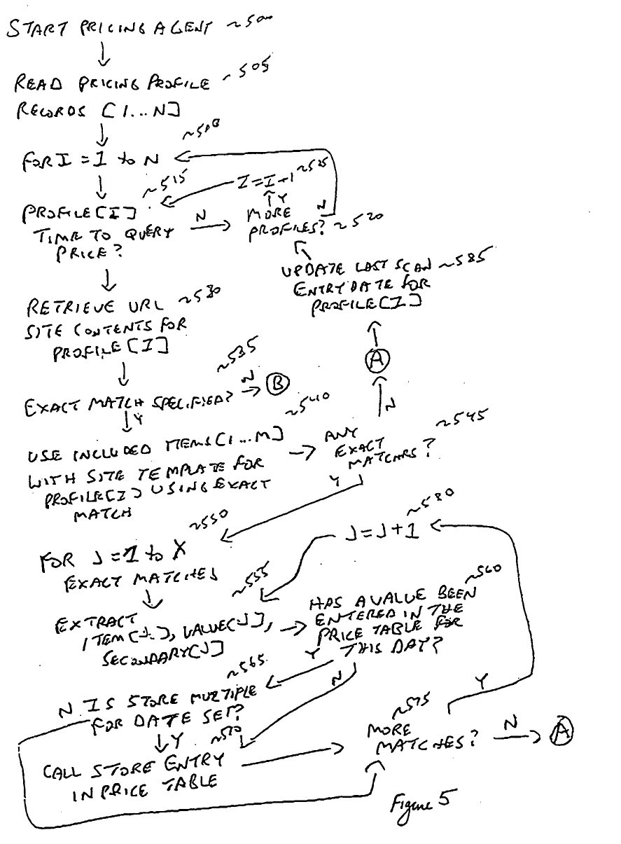

FIG. 2 is a block diagram of the major functional components of the pricing agent. The agent 200 has an associated pricing database 202, as will be described in more detail below in FIG. 3. Pricing agent 200 includes a display module 204 for generating a user dialog through which a user may generate pricing profile records that describe custom site/product searches. FIG. 4 illustrates a representative configuration dialog for viewing, creating or modifying a record from a pricing profile table of the pricing database 202. Pricing agent further includes a data retrieval module 206 for use in controlling a web browser (or other graphics viewing engine operative at the client) to retrieve data from URL sites identified in each pricing profile record. Further, pricing agent 200 includes a data analysis module 208 for analyzing the data retrieved from the specified sites according to criteria specified by the user. A set of one or more templates 210 are used by the pricing agent to invoke search engines at the target sites, to recognize the format of the HTML or other page output generated from such sites and, using user-designated matching techniques, to extract the price information about the queried item(s). The templates may be provided with the pricing agent or user-configured.

The pricing agent program uses the pricing database 300 as illustrated in FIG. 3 to read its configuration information and store its scanned information. The pricing database 300 consists of the following tables: a pricing profile table 302, a threshold table 304, a price table 306, and a site template table 308. Each of these tables is described below.

The pricing profile table 302 is the main table that indicates to the pricing agent 300 which URL sites should be scanned, what they should be scanned for, and what events should occur after scanning. Each record in the pricing profile table 302 is composed of the following fields:

Sequence

The sequence is the unique or primary key identifying the record in the pricing profile table.

URL site The URL site identifies the URL location of the site to scan for price information. The URL may contain any valid HTTP or FTP location.

Included Items

Included items consist of a list of strings that indicate the names of all the prices to search for on the target URL site.

Page Template

The page template is a pointer to a record in the site template table. Each record in the site template table includes a syntax that is used by the pricing agent to parse the contents retrieved from the URL site and retrieve the price values corresponding to the price names in the included items list.

match parameters

The match parameters field can have three values:
(1) exact—price names found in the contents retrieved from the URL site must exactly match a price name in the included items list of names before the price value can be retrieved and stored.
(2) fuzzy ask—price names found in the contents retrieved from the URL site must match a price name in the included items list of names using a fuzzy matching algorithm. If the fuzzy matching algorithm matches a price name in the contents, the pricing agent asks the user whether or not to add the price name to the included items list. If so, the pricing agent adds the name to the list and retrieves and stores the price value. If not, the pricing agent adds the name to the excluded items list.
(3) fuzzy automatic—preferably, price names found in the contents retrieved from the URL site must match a price name in the included items list of names using a fuzzy matching algorithm. If the fuzzy matching algorithm matches a price name in the contents, the pricing agent adds the name to the list and retrieves and stores the price value.

Excluded Items

Excluded items consist of a list of strings that indicate the names of all the prices that will not be explicitly searched on the target URL site. By default, all price names not included in the included items list are excluded, but during a fuzzy match, price names that match the fuzzy algorithm, but are listed in the excluded items list, are excluded from retrieval.

Scan Interval

The scan interval field specifies the period that the URL site is polled and parsed for included items. The pricing agent adds the scan interval to the last scan date to get the next scan date. If the current time is equal to or later than the next scan date, the pricing agent retrieves and parses the contents from the URL site.

Last Scan Date

The last scan date is a timestamp indicating when the contents were last retrieved from the URL site and parsed with the designated site template.
Store Multiple

Store multiple is a boolean field that indicates whether or not a price name in the included items list and the associated price value found in the contents retrieved from the URL site should be stored in the price table if another entry of the same price exists on the same day.

Threshold Expression

Threshold expression contains a boolean expression (e.g., AND and OR operators) with pointers to records from the threshold table that should be checked to trigger events based on the price value. This expression may be null if the user does not want to check any thresholds.

Threshold Event

The threshold event field indicates the action that will occur if the threshold expression is true. The action may be quite varied, e.g., sending an e-mail, logging an event, initiating an e-commerce transaction (e.g., buying a product, selling a product, etc.) or the like.

The threshold table 304 contains records indicating when a threshold condition is reached. Each record in the threshold table is composed of the following fields:

Sequence (Primary Key)

The sequence is the unique or primary key identifying the record in the threshold table.

Threshold Type

The threshold type field indicates what type of value the threshold comparison will operate against. For example, the following values (as well as others) may be supported:
(1) name—name of the item.
(2) price—numerical value representing the price value associated with the item name.
(3) secondary source—string value representing a secondary source matching the price name.

The design can be extended to support additional value types as well.

Threshold Value

The threshold value can be a numerical or string value with which the value to be checked can be compared against with the threshold comparison.

Threshold Comparison

Threshold comparison can be a comparison operator (such as =, >, <, >=, <=, <>, includes, etc.) for which the incoming value to be checked can be compared against the threshold value.

The price table 306 contains records for each item name and value, the source of the information, and the time the information was recorded. Records in the price table are generated by the pricing agent when the pricing agent finds an item in the included items list of a pricing profile table in the contents of a URL that was returned and parsed using a site template.

Each record in the price table 306 may be composed of the following fields:

Item Name

The item name field corresponds to the name of the item that came from the included items list to which this record in the price table was generated from a record in the pricing profile table.

Item Value

The item value field contains the numerical value of the price for the item name.

Timestamp

The timestamp field indicates the date and time that the record in the price table was created.

Primary Source

This source field indicates the URL from which this price name and price value were taken.

Secondary Source

An entity that quoted the item name and price value within the primary source. A secondary source, for example, might be the person who is offering a particular item for sale at a particular price from a site URL targeted by the pricing agent. The secondary source provides an additional depth of detail in the information returned by the agent.

The site template table 308 contains scanning templates that the pricing agent uses in conjunction with records from the pricing profile to search for item entries and their prices from a selected URL. Each record in the site template table may be composed of the following fields:

Scanning Template

The scanning template field consists of a syntax notation, such as a lexical parsing template, that indicates to the pricing agent how to scan for item names and their corresponding prices in the returned contents of the URL.

For example, a scanning template might indicate that the pricing agent should examine all tables in the HTML returned by a web server for a particular URL. The template will identify what data in the HTML (or other data) stream needs be ignored to obtain relevant data requested by the pricing agent. A representative template of this type would indicate, for example, that the first x number of bytes in the returned data stream (representing unimportant data) are ignored, that the second column of a returned table provides item names, that the third column in the table provides price values for the corresponding item names, and so on. Of course, the particular details of a scanning template will depend on the characteristics of the site URL data stream and the information desired for retrieval.

Using the included items list and the scanning template, the pricing agent then extracts each desired item name from the HTML data stream. If an item matches, the pricing agent extracts the price value and stores one or more of the following in an array record in the price table: the name of the item (and whether the item name was an exact or fuzzy match), the value of the item, the primary source, any secondary source, the time the information was scanned, and the like. Preferably, the array includes a triplet of the name of the item, the value of the item, and the secondary source.

FIG. 4 shows an example configuration dialog 400 for viewing, creating or modifying a record from the pricing profile table 302. At the top of the dialog are read-only fields for the record sequence number 402 and last scan date 404. Below these read-only fields are the URL entry field 406 and view button 408. When the user enters a value in the URL entry field 406, the view button 408 is enabled and the user can press the button to open the specified URL in a web browser. This enables the user to easily see the current contents of the URL in a user friendly fashion.

Next, the user can enter, modify or remove values from the included items list 410, as well as the excluded items list 412. These lists are useful to see what fuzzy match item names were added after repeated runs by the pricing agent. Next, the user can choose from a set of radio buttons 414 indicating how matching of entries in the included items list should be performed, whether exact, fuzzy with automatic addition to the included items list, or fuzzy with prompted addition to the included items list.

The dialog also includes fields 416 for the scan interval period, which fields allow the user to specify the number of days, hours, and minutes for the scan period. The read-only field 418 of the Next scan date is calculated by adding the scan interval period to the last scan date, which gives the user the opportunity to see when the next time the site will be scanned. If the site was never scanned before, the user will see the current date and time in this field.

The user can enter, modify or view the threshold expression field 420. This field shows how entries in threshold table 304 can be combined to create a boolean result. The threshold entries are referred to by their sequence number in the table. In the illustrated example, T1 AND T2 indicate that the threshold conditions for records in the threshold table 304 with sequence numbers 1 and 2 must be true before the threshold action in field 422 will be executed. A threshold expression, for example, may indicate that threshold record conditions of item equal to “SoftwareA”, price value greater than “100”, and secondary source of “user1@auction.com” are true. Thus, as can be seen, the pricing agent enables thresholds to be based on a combination of threshold records in the threshold expression. Of course, the above-identified example is merely for illustrative purposes and should not be taken to limit the scope of the present invention.

The threshold action field 422 is enabled if there is a value in the threshold expression field 420. The threshold action field thus shows the event, such as sending an email, that will be executed if the threshold expression is true. The Save and Cancel buttons 424 and 426 allow the user to modify or create the record or cancel viewing or modifications to the record.

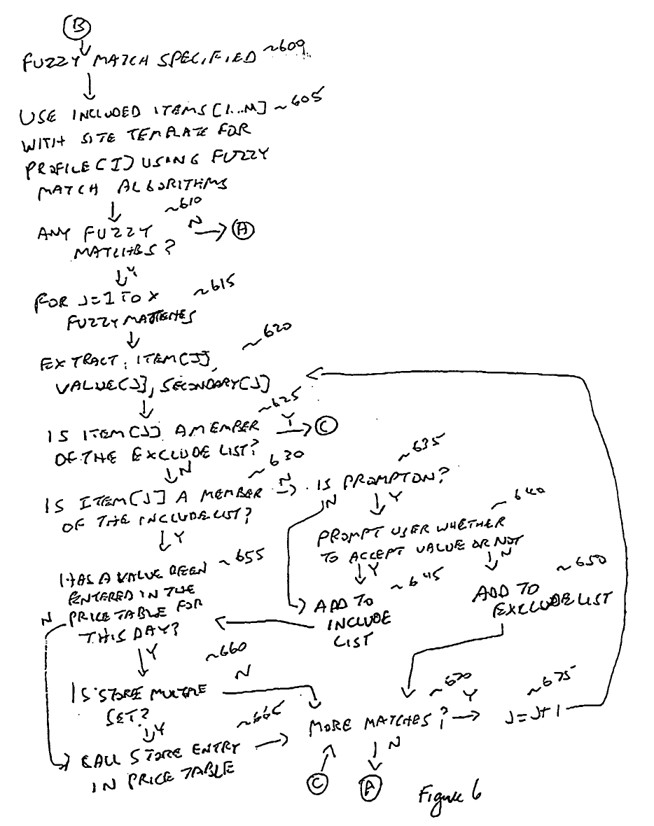

Reference is now made to FIG. 5, which is a flowchart illustrating a representative pricing agent processing flow. When the pricing agent starts, processing begins at step 500 and proceeds to step 505 where the agent reads all the pricing profile records from the pricing profile table 302 that the user previously configured. Next, the agent proceeds to step 510 where the routine loops through each of the pricing profile records beginning from I equals 1 to N, the number of records in the pricing profile table 302.

With the first record and subsequent records, the agent checks the pricing profile record at decision step 515 to determine if it is time to query the price of the item configured in the record. This decision is made by adding together the last scan date with the scan interval. If the computed time equals or exceeds the current time, processing proceeds to step 530. If not, processing proceeds to decision step 520.

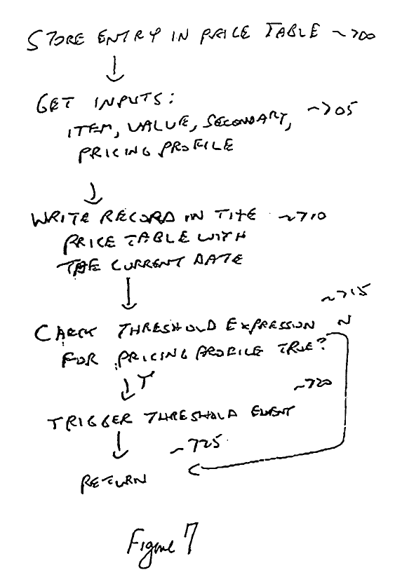

At step 530, the agent retrieves the URL site contents corresponding to pricing profile record[I]. Next, at step 535, the agent checks profile[I] to determine if an exact match was specified. If not, processing proceeds to step 600 in FIG. 6. If an exact match is specified in step 535, processing continues to step 540 where the agent uses the site template specified in profile[I] to parse the contents retrieved from the specified site URL. In a preferred embodiment, the agent searches for the specified included items 1 to M specified in profile[I] within the contents using an exact match.

Next, at step 545, the agent checks to see if there were any exact matches. If not, processing continues at step 585. If the outcome of the test at step 545 is positive, processing continues at step 550 where the agent loops through the items and their prices that match for J equals 1 to the number of X matching records. Next, at step 555, the agent preferably extracts item[J], value[J], and secondary source[J]. The agent then checks at step 560 if a value has already been entered in the price table for this item and this day. If so, processing continues at step 565. If the outcome of the test at step 560 is negative, processing continues to step 570.

At step 565, the pricing agent checks if the store multiple item information for the same date is set to true. If not, processing continues to decision block 575. If so, processing continues at step 570 where the agent calls the store entry in price table method. This method is described in the flowchart of FIG. 7. After return from the method, the agent continues to step 575 where the agent checks to see if there are more exact matches. If so, processing continues to step 580 where counter J is incremented by 1; processing then continues at step 555. If the outcome of the test at step 575 is negative, processing continues at step 585 where the agent updates the last scan entry date with the current time for profile[I] in the pricing profile table.

At step 520, the agent checks if there are more pricing profile records. If so, the agent increments counter I by 1 at step 525 and continues to decision step 515. If not, however, the agent continues to step 510. This completes the main processing flow of the pricing agent.

FIG. 6 shows a preferred processing flow for a fuzzy match specification in profile[I]. The routine begins at step 600 and continues to step 605 where the agent uses the site template specified in profile[I] to parse the contents retrieved from the specified site URL. The agent preferably searches for the specified included items 1 to M specified in profile[I] within the contents using a fuzzy search algorithm. Next, at step 610, the agent checks to see if there were any fuzzy matches. If not, processing returns to step 585 in FIG. 5. If there were any fuzzy matches, processing continues at step 615 where the agent loops through the items and their prices that fuzzy match for J equals 1 to the number of X matching records. Next, at step 620, the agent preferably extracts item[J], value[J], and secondary source[J]. The agent then checks at step 625 if the item value is a member of the exclude items list for profile[I]. If so, processing continues to step 670. If the item value is not a member of the exclude items list for profile[I], processing continues at step 630 where the agent checks to see if item[J] is an exact match of a member already in the included items list. If so, processing continues at step 655. If item[J] is not an exact match of a member already in the included items list, processing continues to step 635.

At step 635, the agent checks if the fuzzy match with prompt on selection was specified for profile[I]. If not, processing continues at step 645. If the fuzzy match with prompt on selection was specified for profile[I], processing continues at step 640 where the agent prompts the user whether to accept the fuzzy match item name and add it to the included items list for profile[I]. If not, processing continues at step 650 where the agent adds the fuzzy match item name to the excluded items list for profile[I]; processing then continues at step 670. If the outcome of the test at step 640 is positive, the agent adds the fuzzy match item name to the included items list for profile[I] at step 645; processing then continues at step 655.

At step 655, the agent checks if a value has already been entered in the price table for this item and this day. If so, processing continues at step 660. If the outcome of the test at step 655 is negative, processing continues at step 665.

At step 660, the pricing agent checks if the store multiple item information for the same date is set to true. If not, processing continues at step 670. If the outcome of the test at step 660 is positive, processing continues to step 665 where the agent calls the store Entry in price table method. After return from the method, the agent continues to step 670 where the agent checks to see if there are more fuzzy matches. If so, processing continues to step 675 where counter J is incremented by 1; processing then continues at step 620. If the outcome of the test at step 670 is positive, processing returns to step 585 in FIG. 5.

FIG. 7 illustrates a processing flow for the store entry in price table method. Processing begins at step 700 and continues to step 705 where the method takes the inputs of the item name, item value (price), secondary source information, and the associated pricing profile record that the agent used to determine the item, value, and secondary source information. Next, at step 710, the method writes the record into the price table with the input information and current date; processing then continues to step 715. At this step, the method checks the threshold expression stored with the pricing profile record using the input values to the method. If the threshold expression is not true, the method returns to block 725. If the expression is true, however, the method continues at step 720 to trigger the threshold event stored with the pricing profile record before returning from the method at step 725. This completes the processing.

The present invention provides numerous advantages as compared to the prior art. The pricing agent enables a user to identify particular site URLs and products that he or she wishes to review on a periodic basis. The agent then retrieves data from the site and parses that data according to a configurable site template. Data that satisfies user-configurable conditions may then be provided to the user and/or used to define one or more trigger actions. The agent thus enables users to ascertain the value of given merchandise over a period of time. The agent can provide current and historical prices, as well as the location where the prices were posted. The data also shows customers general pricing trends, such as whether the item is increasing or decreasing in value.

The graphical interface to the pricing agent allows all the information in the pricing database to be queried and search criteria altered as desired. One of ordinary skill in the art will appreciate that, given such data, the interface may readily be configured to show graphs of price trends and mean prices for selected items, the frequency that selected item appeared on a site, as well as other statistical information gleaned from the collected data.

A given user may also run the pricing agent against products on a target site (e.g., the user's own site) to enable individual or business customers to ascertain the value of their inventory and whether their items show a tendency to scarcity or oversupply. From this information, the individual or business entity can make more informed decisions on how to price their items for the market.

This design has significant advantages over current techniques, in particular shopping bots, which cannot provide automatic historical tracking of pricing. Additionally, some sites intentionally block shopping bots from scanning their site. Because the pricing agent runs from an individual customer or business connection, the queries appear as individual transactions, not the bulk shopping bot queries that targeted sites attempt to block.

In addition, while some business sites may already track pricing and frequency information on the products that they offer, this information is not publicly available. The pricing agent provides a convenient and easy way for individual customers and businesses to collect and query the information that they need.

One of ordinary skill will appreciate that the flowcharts illustrate a processing flow with the agent checking each pricing profile record sequentially. Alternatively, the agent could spin off multiple threads with each thread handling a profile record. For performance, the threads could sleep until their time to query the included items list from the contents of their target site URL.

The following sample site template indicates to the pricing agent that all tables in the retrieved HTML file should be parsed, that the second column in a table row is the item name, that the third column is the item price, and that the fourth column is the item secondary source. If the pricing profile table record indicates that the parsed item name should exactly match a name in the included items list, the pricing agent will check the parsed % ITEM_NAME % to see if it exactly matches a name in the list. If so the parsed item name, item price, and item secondary source will be extracted together and processed as described in the flow.

<HTML>
<BODY>
<TABLE 1..N>
<TR>
<TD>
<TD>%ITEM_NAME%
<TD>%ITEM_PRICE%
<TD>%ITEM_SECONDARY_SOURCE%
</TR>
</TABLE>
</BODY>
</HTML>

As noted above, the inventive mechanism is preferably implemented in or as an adjunct to a web browser. A convenient implementation is a web browser plug-in, although this is not a requirement. Thus, the invention does not require any modifications to conventional server hardware or software. Although not meant to be limiting, the above-described functionality is preferably implemented as standalone native code or, alternatively, as a Java applet or application. Generalizing, the above-described functionality is implemented in software executable in a processor, namely, as a set of instructions (program code) in a code module resident in the random access memory of the computer. Until required the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network.

In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

Further, as used herein, a Web “client” should be broadly construed to mean any computer or component thereof directly or indirectly connected or connectable in any known or later-developed manner to a computer network, such as the Internet. The term Web “server” should also be broadly construed to mean a computer, computer platform, an adjunct to a computer or platform, or any component thereof. Of course, a “client” should be broadly construed to mean one who requests or gets the file, and “server” is the entity which downloads the file.

Although the present invention has been described in the context of the Internet, one of ordinary skill in the art will appreciate that the principles of the present invention may also be useful in any type of heterogeneous network environment. Thus, the use of a web browser for implementing this invention is not a limitation. The inventive technique may be implemented in any client application that communicates with a server using any known or later-developed protocol.

1-16. (canceled)

17. A database for use in managing a pricing agent in a computer, comprising:
a pricing profile table comprising a set of profile records, each record identifying a URL site, a list of included items, a scan interval, and a pointer to a site template;
a site template table comprising a set of site templates, each site template comprising lexical instructions for parsing a data stream to identify given data; and
a price table comprising a set of pricing records, each record identifying an item name, an associated price value, and at least one source.

18. The database of claim 17 further including a threshold table comprising a set of threshold records, each record identifying a threshold type, a threshold value, and a threshold comparison operator.

19. The database of claim 17 wherein each profile record further includes a list of excluded items.

20. A computer, comprising:
a browser;
a database comprising:
a pricing profile table comprising a set of profile records, each record identifying a URL site, a list of included items, a scan interval, and a pointer to a site template;
a site template table comprising a set of site templates, each site template comprising lexical instructions for parsing a data stream to identify given data; and
a price table comprising a set of pricing records, each record identifying an item name, and associated price value, and at least one source; and
code executable in the browser during processing of a given pricing profile record at the scan interval for parsing data retrieved form the URL site according to the site template to generate a data record for each included item.

21. The database of claim 18, wherein price data for an item name is collected over a given period of time to produce historical data.

22. The database of claim 17, wherein the database receives queries from a pricing agent.

23. The database of claim 22, wherein the pricing agent provides data to the database using the set of profile records.

24. The database of claim 17, wherein the pricing table provides an identification of URL sites to be scanned for data.

25. The database of claim 18, wherein the threshold table indicates when a threshold condition is reached to trigger a threshold event

26. The database of claim 25, wherein threshold event is a sending of an email.

27. The database of claim 25, wherein the site templates include matching criteria.

28. The database of claim 25, wherein each site template includes a scanning template that indicates who to scan for item names and corresponding prices.
